(19) United States
(12) Patent Application Publication
(10) Pub. No.: US 2026/0018073 A1
(43) Pub. Date: Jan. 15, 2026

(54) DYNAMIC GENERATION OF PERSONALIZED CONTENT FOR ACCELERATED EXAM PREPARATION USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Philip Hewinson, Woking (GB); Samy Aboel-Nil, Austin, TX (US); Niraj Patel, Dubai (AE); Janet Demir, Ortaca (TR); Akshay Mate, Nanaimo (CA); Matthew Caponi, Vancouver, WA (US)

(73) Assignee: 2hr Learning, Inc., Austin, TX (US)

(21) Appl. No.: 19/269,565

(22) Filed: Jul. 15, 2025

Related U.S. Application Data
(60) Provisional application No. 63/671,739, filed on Jul. 15, 2024.

(51) Int. Cl. G09B 5/06; G06T 13/40; G10L 13/08

(52) U.S. Cl. CPC G09B 5/06; G06T 13/40; G10L 13/08

(57) ABSTRACT

A method for guiding an artificial intelligence (AI) engine to generate and deliver educational content through an AI-generated tutor on an online learning platform. The method involves collecting input data from multiple sources, including educational, historical, image, and voice databases. Based on this data, prompts are generated to direct the AI engine in producing curriculum-aligned scripts. A digital AI tutor is created using the collected data, including synthesizing a voice that mimics the tutor and generating a corresponding visual representation. The script, voice, and visual elements are integrated into an animated video of the AI tutor. The video is then delivered and displayed to users on the learning platform at a scheduled time to facilitate personalized, standards-based instruction.

### CROSS-REFERENCE TO RELATED APPLICATION(S)

This application claims the benefit under 35 U.S.C. § 119 (e) and 37 C.F.R. § 1.78 of U.S. Provisional Application No. 63/671,739, which is incorporated by reference in its entirety.

### FIELD OF THE INVENTION

The present invention relates to the field of electronics, and more specifically to the generation of learning videos including AI tutors for enhancing the understanding of users on a corresponding learning topic.

### BACKGROUND OF THE INVENTION

Online learning platforms are gaining popularity as these platforms provide access to a wide variety of courses, training programs, and learning resources, and a user can access these resources from any remote location. Additionally, users can take live online classes via online learning platform. However, the traditional online learning approaches relied on one-way lectures and a one-size-fits-all curriculum that may not help users effectively. These conventional online learning approaches often lead to disengagement and a lack of motivation among users. Further, conventional online learning platforms often fail to provide timely and personalized support to users. Conventional adaptive learning systems are also being employed to cater to online learning methods but these systems often lack the depth of engagement and feedback to the users. Conventional online learning platforms implement assessment methods to analyze student's performance data. However, these methods fail to assess the engagement of users. The methods often fail to provide intervention to the users.

### SUMMARY

In at least one embodiment, a method guides an AI (Artificial Intelligence) engine to generate content and delivers the content to a user using a generated AI tutor via an online learning platform including executing code using one or more processors of a computer system to cause the computer system to perform operations including collecting one or more input data from a plurality of sources. The plurality of sources include educational databases, historical databases, image, and voice databases. The operations also include generating prompts to guide and constrain the AI engine to create the content based on the received one or more input data. In addition, the operations include providing the generated prompts to the AI engine to guide and constrain the AI engine to perform creating a script of the content that aligns with a curriculum standard. The AI engine also performs preparing AI tutor generation based on data received from the educational databases, and historical databases. Furthermore, the AI engine employs a text-to-speech converter that synthesizes a voice that mimics the voice of the AI tutor and generates a visual representation of the AI tutor that is linked to the script. The operations further include integrating the generated script, synthesized voice, and visual representation to generate an animated video of the AI tutor to be used during an online learning session. Finally, the operations include receiving the AI-generated video and displaying it to the user using the online learning platform. The generated video is displayed at a specific time.

In a further embodiment, a system to guide and constrain an AI (Artificial Intelligence) engine to generate content and deliver the content using an AI tutor to a user using an online learning platform includes one or more processors. The system also includes a memory, coupled to the one or more processors, that includes code that when executed cause the one or more processors to perform operations including collecting one or more input data from a plurality of sources using a collector. The plurality sources include educational databases, historical databases, image, and voice databases. The operations also include generating prompts using a prompt generator to guide the AI engine to create the content based on the received one or more input data. In addition, the operations include transferring the generated prompts to the AI engine to create a script of the content that is to be provided to the AI tutor using a text generator based on data received from the educational databases, and historical databases. The AI engine also employs a text-to-speech converter for synthesizing a voice that mimics the voice of the AI tutor. Furthermore, the AI engine creates a visual representation of the AI tutor using an image generator based on deep learning techniques. The operations further include integrating the generated script, synthesized voice, and visual representation to generate a video using a video integration module. The video of the AI tutor is used during an online learning session. Finally, the operations include receiving the AI-generated video and displaying it to the user via a user interface on the online learning platform. The generated video is delivered to the user at a specific time.

In at least one embodiment, a system and method generate and deliver AI-driven educational content via an online learning platform. Specifically, it guides and constrains an artificial intelligence (AI) engine to produce personalized, curriculum-aligned instructional content, which is delivered to users through a dynamically generated AI tutor.

In at least one embodiment, the system and method collect diverse input data from multiple sources, including educational and historical databases, image libraries, and voice databases. The system and method then generate contextually relevant prompts to direct the AI engine in creating a script aligned with curriculum standards. In at least one embodiment, a synthetic voice, generated through text-to-speech conversion, mimics the AI tutor's voice, while a visual representation of the tutor is also generated using deep learning-based image synthesis. The components such as script, voice, and visuals are integrated into an animated video of the AI tutor. The video is delivered and displayed to users on the online learning platform at a scheduled time, facilitating an engaging and personalized learning experience. In at least one embodiment, the system and method enable scalable, automated, and interactive online education, which may be real-time through real-time generation or pre-recorded video AI-generated tutors, providing customized content delivery while maintaining alignment with curriculum standards.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary tutor generation system to guide an Artificial Intelligence (AI) engine for the generation of tutors for adaptive learning.

FIG. 2 depicts an exemplary tutor generation process using Artificial Intelligence for adaptive learning.

FIGS. 3 and 4 depict the steps involved in the video creation process to provide a contextual learning video to the user.

FIG. 5 depicts an exemplary AI guided and constrained, curriculum aligned video generation sequence diagram which is an embodiment of AI-based learning process.

FIG. 6 depicts an exemplary curriculum-student alignment, video generation process which is an embodiment of AI-based learning process.

FIG. 7 illustrates an AI guided and constrained, feedback and video generation the sequence diagram which is an embodiment of AI-based learning process.

FIG. 8 represents a personalized learning video generation process which is an embodiment of the AI-based learning process.

FIG. 9 depicts an exemplary diagram showing data structures used to structure and organize data for video generation utilized by the AI-based learning system.

FIG. 10 depicts an exemplary diagram showing data structures used to structure and organize data for assistance to the student based on the student's performance and learning curve utilized by the AI-based learning system.

FIG. 11 depicts an exemplary learning video generation and delivery process for creating the learning video and displaying the video at a specific time.

FIG. 12 depicts an exemplary educational user interface displaying educational topics to be selected by the user for adaptive learning.

FIG. 13 depicts another exemplary educational user interface showing a question presented to the user while learning.

FIGS. 14-15 depict yet another user interfaces where the AI tutor explains the concept associated with the presented question.

FIG. 16 depicts an exemplary user interface displaying the correct answer, as submitted by the user, to the presented question.

FIG. 17 depicts an exemplary user interface of a scenario where the AI tutor pops up at a specific time, when the user submitted incorrect answer to a presented question.

FIGS. 18 and 19 depict a set of exemplary educational user interfaces, where the AI tutor appears at a specific time to explain a concept and the user interacts with the AI tutor via a chat option.

FIGS. 20-24 depicts an exemplary embodiment where the AI tutor pops up while the user is practicing a test in a practice test mode.

FIG. 25 depicts a user interface showing user interaction with an AI tutor via a chat option, while the AI tutor is explaining a concept in parallel.

FIG. 26 depicts an exemplary network environment in which the system of FIG. 1 and the process of FIG. 2 may be practiced.

FIG. 27 depicts an exemplary specially programmed computer system.

### DETAILED DESCRIPTION

A system and method utilizes guided and constrained artificial intelligence (AI) engine for contextual online learning characters as AI tutors. The particular characters are a matter of design choice and are, for example, historical characters (also referred to as historical figures and historical persona). The system includes one or more processors for executing code to perform operations like the creation of realistic videos of the AI tutor with accurate scripts and voices to provide a more immersive and interactive learning experience. A method for delivering targeted and relevant educational input from historical figures at critical moments in a student's learning journey. This system identifies key learning opportunities and utilizes AI-driven historical figures to provide contextualized guidance and insights, aiming to enhance understanding and retention of the material. For example, a short “what you need to know” video is delivered to students after they answer a question incorrectly.

The system uses the AI engine to create video scripts to ensure academic accuracy and alignment with student curriculum, such as Common Core State Standards or modifications thereof. The system implements voice generation technology to synthesize speech that matches the character's voice with the AI tutor. The system uses image processing software to create a visual representation of the selected character as the AI tutor. Further, the AI engine uses video stitching software to combine the script, the voice, and the image to generate a video. The generated video is displayed to the user at a specific time. The system delivers personalized educational videos to users based on an interaction of the user with the online learning platform, user requirements, etc.

While the tutor generation system using Artificial Intelligence for adaptive learning presented herein makes use of specific reference to dynamic, adaptive, and personalized learning for the students using an AI tutor, it is to be appreciated that the description is also equally applicable to school teachers, parents teaching their child at home, the student doing self-tutoring, coaching tutors, adults learning for their career development, employees in corporate training, parents for parenting education, children for craft, music and other education, elderly people for medical guidance, medical staff for guidance and so on.

Similarly, the tutor generation system using Artificial Intelligence for adaptive learning disclosed herein has mentioned the AI tutor i.e., an AI tutor teaching the student as, for example, a historical persona. However, the AI tutor is not limited to the historical persona. The AI tutor may include another character of the user's choice like cartoon, animations, political, film stars, and so on. In at least one embodiment, the AI tutor is generated in real-time by an AI-based learning system.

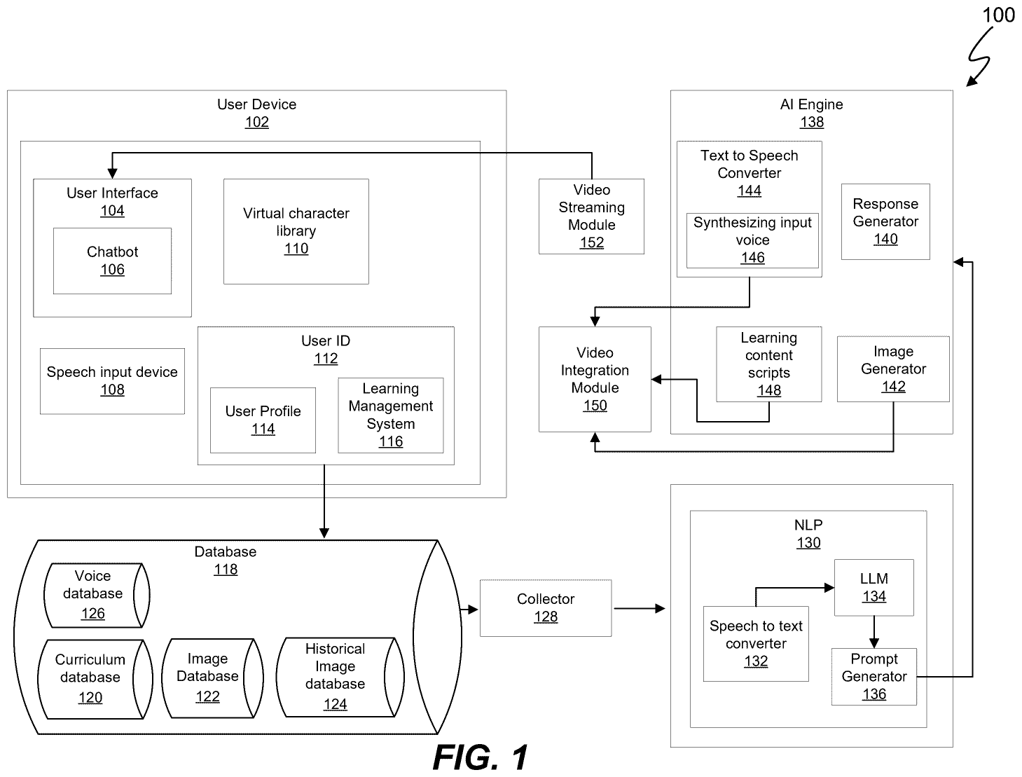

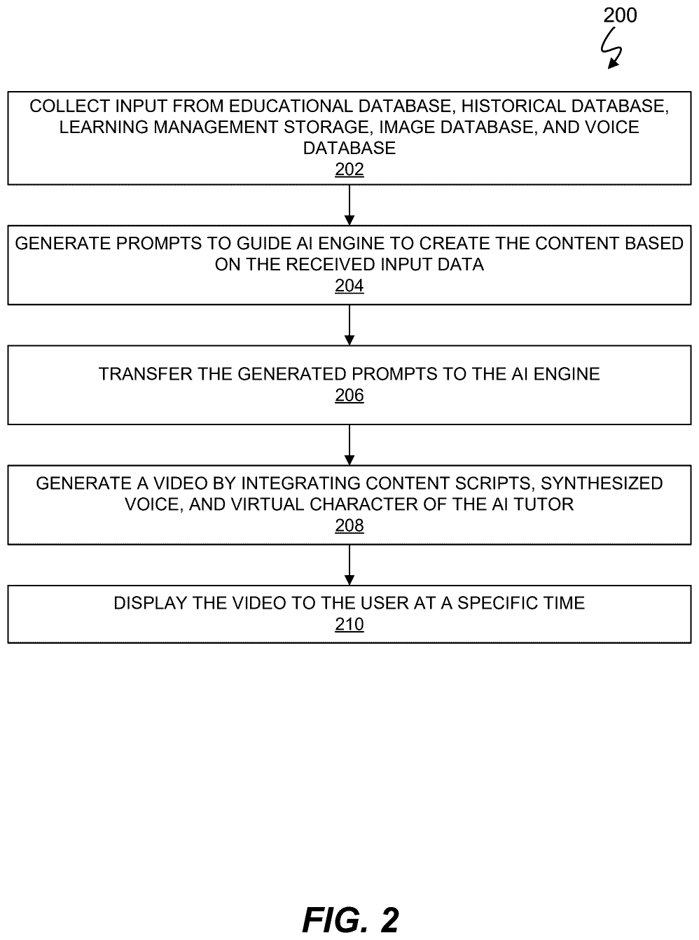

FIG. 1 depicts an exemplary AI-based learning system 100 to guide the AI engine 138 to generate the AI tutor-based video for contextual learning. FIG. 2 depicts an exemplary AI-based learning process 200 to guide the AI engine 138 to generate the video for the contextualized learning utilized by the AI-based learning system 100.

The AI-based learning system 100 comprises an AI Engine 138 that generates content and delivers the content by presenting an AI tutor as an AI tutor to a user over a user interface 104. The user interface 104 is accessed by the user through a user device 102. In an embodiment, the user interface 104 includes a chatbot 106 for interaction and learning support.

The AI-based learning system 100 includes a collector 128 to collect input data from a plurality of sources including an educational curriculum database 120, a learning management system 116 (a.k.a LMS 116), a historical image database 124, an image database 122, and a voice database 126. The AI-based learning system 100 further includes a prompt generator 136 that generates prompts to guide the AI engine 138 to create a video for learning purposes based on the received input data from collector 128. The one or more databases are operatively coupled to one or more processors of a computer system that is also coupled to a memory that stores executable code to perform the below-mentioned operations. The term “database” includes databases with database management systems and other ways of storing data such as JSON files.

Referring to FIGS. 1 and 2, in operation 202, the input data is collected from a plurality of databases. The collector 128 accesses the databases from the above-mentioned sources and transfers the collected input data to the prompt generator 136. In operation 204, a prompt generator 136 generates the prompts with the help of a speech-to-text converter 132 and a large language model (LLM) 134, and transfers the prompts to the AI engine 138, in operation 206. In operation 208, the AI engine 138 generates a video including an AI tutor to explain a particular topic to the user. The AI engine 138 creates the video by integrating the learning content scripts 148, synthesizing input voices, and the visual representation of the AI tutors taken from an image generator 142. The video is displayed to the user via a user interface 104. The AI-based learning system 100 includes a analysis of a user's requirement or performance to identify an optimal moment for learning interventions.

The AI-based learning system 100 uses a speech-to-text converter 132 to convert spoken input from users into text format for further processing. The speech-to-text converter employs natural language processing (NLP) and advanced machine learning algorithms to enhance the accuracy of the generated scripts and to make the scripts more engaging. NLP techniques enable the speech-to-text converter 132 to interpret and analyze the transcribed text more intelligently, taking into account factors such as context, syntax, and semantics.

The voice generation technology synthesizes speech that matches the character to be presented as the AI tutor. The voice generation technology involves analyzing linguistic patterns, phonetics, and emotional nuances and generates lifelike voices. The speech synthesizing process implements text-to-speech (TTS) technology. The TTS technology uses a combination of linguistic analysis and voice modeling and converts written text into spoken words. Voice generation technology produces accurate and natural-sounding voices by analyzing the pronunciation, intonation, and rhythm of human speech.

Operation 208 further involves creating a video of the AI tutor speaking the generated audio response. The response is generated with the help of a response generator 140 based on the guiding prompts provided to the AI engine 138 by the prompt generator 136.

A Natural Language Processor (NLP) 130 is integrated within the AI engine 138 and is configured to generate a response in a manner as disclosed in U.S. Provisional Patent Application No. 63/671,739, which is incorporated herein by reference.

The AI Engine 138 generates responses per the user's requirements. The AI Engine 138 considers a user's learning progress, performance metrics, etc., while providing learning assistance to the user. The AI engine 138 analyzes student performance to identify learning opportunities. Further, the AI engine 138 links the curriculum input data to the image input and selects the most relevant character to explain a particular topic. The image-selected character is animated and narrates the scripted content in the video based on the user's interaction with the AI-based learning system 100 or based on the user's response.

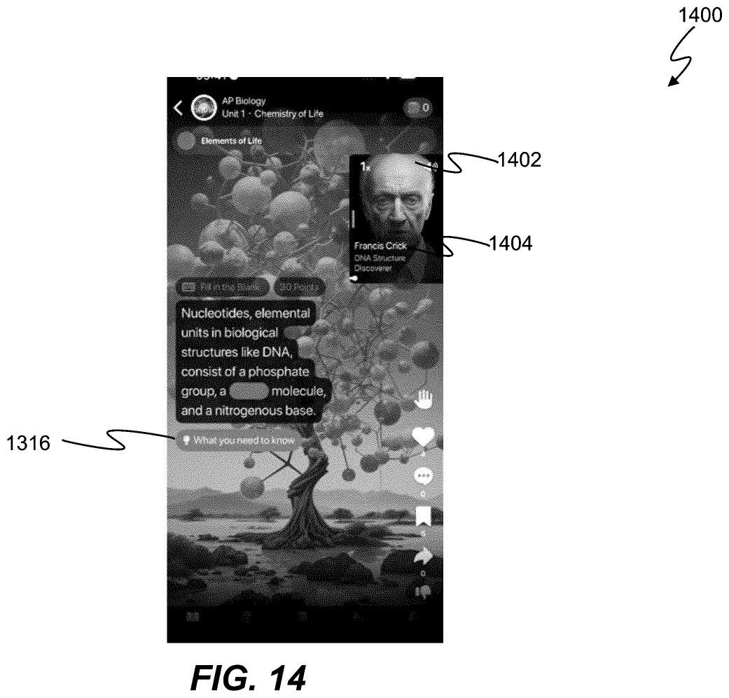

The video integration module 150 combines data from the generated learning content script 148, synthesized voice 146, and visual representation generated from the image generator 142 to generate a video. The video includes speaking AI tutors, such as depicted in FIGS. 14-19 and 25 that are transformed from image input. A video streaming module 152 streams video responses from the AI tutors directly onto the user interface 104 of the AI-based learning system 100 based on the user's interaction. The AI tutor appears on the video explaining a particular topic when the user clicks on an icon, seeks more suggestions, does not know the correct answer to a particular query, etc. For instance, if a user expresses confusion on a topic, the AI tutor can adapt its response accordingly, providing further clarification or additional resources.

The AI tutors are integrated within the user interface 104 and are selected by the user based on his/her preferences. For example, a small kid may use cartoon characters as a tutor to guide him in the online learning sessions. Similarly, if a student wishes to learn about the US Civil Rights Movement, he may choose Martin Luther King Jr. The AI tutors offer personalized learning recommendations based on user preferences and learning history.

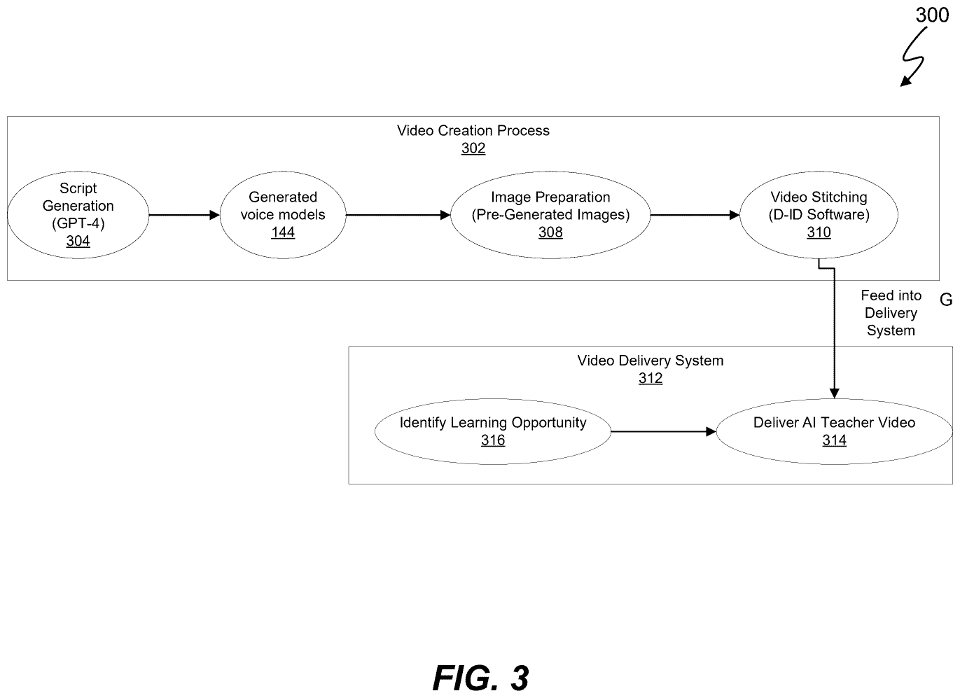

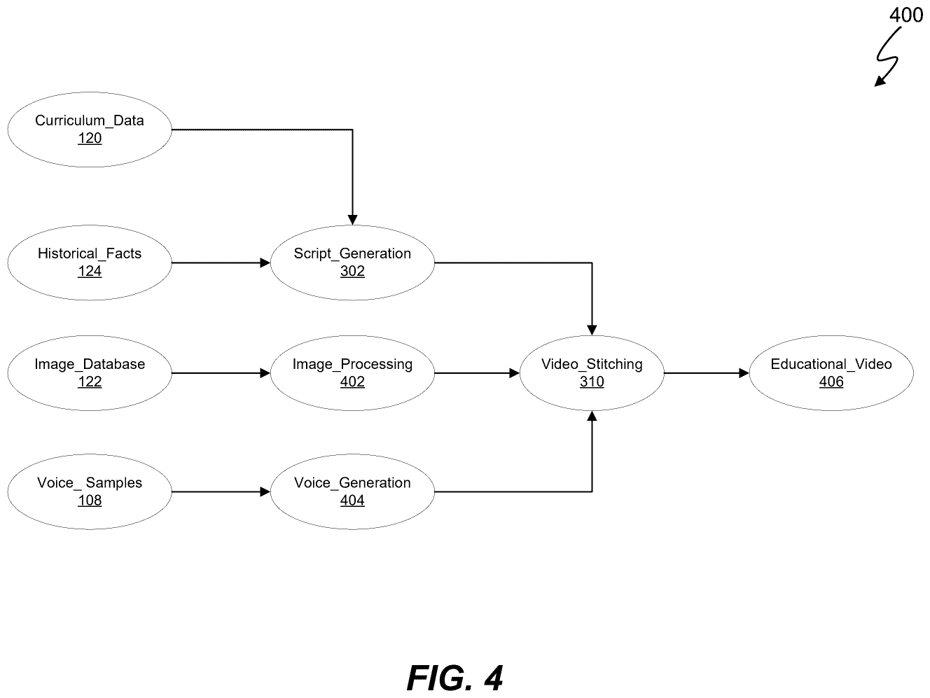

FIGS. 3 and 4 depict the steps involved in the video creation process to provide a contextual learning video to the user. Referring to FIGS. 1, 3, and 4, video creation process 300, in conjunction with FIG. 1, involves accessing the curriculum and historical databases. The AI-based learning system 100 uses natural language processing 130 and machine learning to generate scripts from the information stored in the databases. The script is generated to ensure that academic accuracy is maintained and to make the learning content more engaging for the users. Then, the AI-based learning system 100 obtains a recording of the voice samples that match with the AI tutor. The AI-based learning system 100 synthesizes the recorded voice to create an interactive speech of the AI tutor for the learning content. Further, the AI-based learning system 100 receives the user's voice input from a speech input device 108 and initializes communication between the user and the AI tutor. The user's voice is given to a speech-to-text converter 132 to convert the received voice of the user into text format. The data is collected and passed to the LLM 134.

Further, the image database 124 has a wide collection of images of different personalities including but not limited to history, science, literature, etc. The system uses graphic design and implements deep learning techniques to create realistic visuals of the collected images.

The learning content script 148 is generated using script generator such as GPT-4 at 304. The synthesized input voice 146 is generated using voice models 144, and the pre-generated images 308 are combined using suitable video stitching software 310 to create a video. The video is delivered to the user over the user interface 104. The video streaming module 152 of FIG. 1 delivers content to the user in such a manner that the user is presented with dynamic and interactive learning sessions through an AI tutor, providing assistance or guidance to the user. The content to be delivered further considers responses from the user. The video delivery system 312 finds learning opportunities for the user. For example, the video delivery system 312 identifies learning opportunities 316 for the user or identifies a particular topic on which the user is facing a challenge. Below are exemplary prompts designed to produce an educational video featuring a historical figure who teaches a subject aligned to a student's grade and difficulty level. The “learning_content” field generated is the script used when generating the learning aid video.

### Examples

Question: Which of the following best describes the impact of the First Great Awakening on the British colonies?

### Options:

A. It led to increased unity and a shared sense of identity among the colonies. [Correct]
   Explanation: Correct. The First Great Awakening crossed regional boundaries and helped foster a sense of shared experience and identity among the colonies, despite their differences.
B. It strengthened ties with Britain by reinforcing shared Anglican doctrine and practices.

### [Incorrect]

Explanation: Incorrect. The First Great Awakening often challenged the Anglican church and emphasized personal spiritual experience over doctrine, so it did not strengthen ties with Britain in this way.
C. It caused the colonies to reject British religious influence and practices. [Incorrect]
   Explanation: Incorrect. While the First Great Awakening did challenge the authority of established churches, it did not lead to a wholesale rejection of British religious influence.
D. It created greater religious uniformity by suppressing minority sects and beliefs.

### [Incorrect]

Explanation: Incorrect. The First Great Awakening actually promoted greater religious diversity and the spread of new denominations, rather than suppressing minority sects.

### Learning Content:

Here's what you need to know: The First Great Awakening was a religious revival movement that spread through the British colonies in the 1730s and 1740s. It emphasized personal piety and challenged the authority of established churches. The movement helped foster a sense of shared colonial identity as it crossed regional boundaries. It also contributed to changing cultural attitudes by promoting spiritual egalitarianism and individual religious experience.
Question: Which of the following accurately describes a difference between the abolitionist movement and the early women's rights movement in the methods they used to advance their ideals?

### Options:

A. The abolitionist movement focused on pamphleteering, while the women's rights movement primarily held rallies. [Incorrect]
   Explanation: Incorrect. Both the abolitionist and women's rights movements used a variety of tactics, including pamphleteering and public gatherings, to spread their messages.
B. The abolitionist movement relied on religious inspiration, while the women's rights movement was driven by intellectual ideals. [Incorrect]
   Explanation: Incorrect. Both movements drew inspiration from a mix of religious and intellectual sources, such as the Second Great Awakening and Enlightenment ideals of equality.
C. The abolitionist movement formed national organizations, while the women's rights movement remained localized. [Correct]
   Explanation: Correct. The abolitionist movement established national organizations like the American Anti-Slavery Society, while the early women's rights movement was more locally organized through events like the Seneca Falls Convention.
D. The abolitionist movement worked through governmental channels, while the women's rights movement operated outside the government. [Incorrect]
   Explanation: Incorrect. Both movements primarily worked outside of government institutions in their early stages, using grassroots tactics to build support for their causes.

### Learning Content:

Here's what you need to know: In the early 19th century, reform movements like abolitionism and women's rights advanced their ideals through grassroots efforts outside the government. While both used tactics like pamphleteering and rallies, the abolitionist movement established national organizations earlier. In contrast, the women's rights movement began with more localized activities like the Seneca Falls Convention. Despite some differences, both movements drew inspiration from religious awakenings and intellectual ideals to challenge societal norms.
Question: How did the market revolution's societal changes contribute to the Second Great Awakening?

### Options:

A. The Second Great Awakening was a direct response against the secular influences of the market revolution. [Incorrect]
   Explanation: Incorrect. While the Second Great Awakening did respond to changes from the market revolution, it was not a simple backlash against secular influences. Religious leaders adapted their messages to address the new economic and social realities.
B. Improved transportation networks allowed the Second Great Awakening to spread to new regions. [Incorrect]
   Explanation: Incorrect. Although advances in transportation did help spread religious ideas, they were not the primary driver of the Second Great Awakening. The religious fervor was more a response to societal changes than a result of logistical improvements.
C. The growth of industrial cities created new anxieties that drove people to seek solace in religion. [Correct]
   Explanation: Correct. The rapid urbanization and societal changes brought about by the market revolution left many feeling displaced and uncertain. In response, people turned to religion and revival movements that offered community and reassurance.
D. The increased availability of mass-produced religious texts led to a decline in church attendance. [Incorrect]
   Explanation: Incorrect. While mass production made religious texts more available, this did not lead to a decline in church attendance. In fact, the opposite occurred as people sought community and stability through increased religious participation.

### Learning Content:

Here's what you need to know: The market revolution's social changes, like urbanization and shifting work conditions, contributed to the Second Great Awakening. As people faced new economic realities and societal upheaval, many turned to religion for stability and community. Protestant leaders adapted their methods and messages to address these changes, fueling the religious fervor of the era.
Question: Which of the following best describes the impact of maize cultivation on settlement patterns in the American Southwest?

### Options:

A. It was the sole factor in the establishment of sedentary agricultural communities.

### [Incorrect]

Explanation: Incorrect. While maize cultivation was a significant factor, it was not the sole factor in the establishment of sedentary agricultural communities. Other factors such as climate, water availability, and social structures also played important roles.
B. It was uniformly adopted and utilized in the same way by all Southwestern societies.

### [Incorrect]

Explanation: Incorrect. The adoption and utilization of maize was not uniform across all Southwestern societies. Its impact varied based on local environmental conditions, existing subsistence practices, and cultural factors.
C. It supported the development of permanent settlements in suitable regions. [Correct]
Explanation: Correct. The spread of maize cultivation enabled a more stable food source in regions with favorable conditions, encouraging the development of permanent sedentary agricultural communities in the American Southwest where it was ecologically viable.
D. It discouraged settlement in areas where the crop was unsuitable. [Incorrect]
Explanation: Incorrect. While maize did not support increased settlement in all areas, such as those with unsuitable climates or soils, it did not universally discourage settlement. In some of these regions, societies continued mobile lifestyles for various reasons.

### Learning Content:

Here's what you need to know: The spread of maize cultivation from present-day Mexico into the American Southwest had a significant but varied impact on settlement patterns. In regions with suitable climate and soil, maize provided a stable food source that supported the development of permanent sedentary agricultural communities. However, the crop's influence was not uniform, as environmental factors and existing cultural practices led to diverse outcomes in settlement and social structures across different Southwestern societies.
Question: Which of the following technological advancements contributed most significantly to Western dominance in the global political order at the start of the 20th century?

### Options:

A. Advancements in electricity distribution [Incorrect]
   Explanation: Incorrect. While advancements in electricity distribution modernized cities and factories, they were not as critical to Western dominance as the steam engine's impact on industry and transportation.
B. The invention of the telephone [Incorrect]
   Explanation: Incorrect. While the invention of the telephone revolutionized communication, it did not play as direct a role in maintaining Western dominance as industrial and military technologies.
C. The widespread adoption of the steam engine [Correct]
   Explanation: Correct. The steam engine significantly increased industrial productivity and transportation capabilities in Western nations, bolstering their economies and military strength.
D. The development of the assembly line [Incorrect]
   Explanation: Incorrect. Although the assembly line improved manufacturing efficiency, it was developed after the start of the 20th century and built upon existing industrial technologies like the steam engine.

### Learning Content:

Here's what you need to know: At the beginning of the 20th century, Western dominance was maintained through industrial strength, superior military technology, and economic power. The widespread adoption of the steam engine played a crucial role in this by boosting industrial productivity and transportation capabilities in Western nations. This technological advancement allowed the West to efficiently manufacture goods and build powerful militaries, securing their global political and economic preeminence.
</examples>
You are an experienced educator tasked with creating a multiple-choice question (MCQ) for an AP United States History lesson. Your goal is to assess a specific learning objective while adhering to educational standards and a specified difficulty level.
First, review the lesson context and educational standards:

<lesson_context>
<lesson_title>
{{standardCluster}}
</lesson_title>
<lesson_nodes>
{{knowledgeSchemaNodeStatement}}
</lesson_nodes>
</lesson_context>
<educational_standards>
<parent_standards>
{{ancestor3StandardDescription}}
{{ancestor2StandardDescription}}
{{ancestor1StandardDescription}}
</parent_standards>
<current_standard>
{{standardDescription}}
</current_standard>
</educational_standards>

Now, consider the assessment boundary and common misconceptions:

<assessment_boundary>
{{assessmentBoundary}}
</assessment_boundary>
<common_misconceptions>
{{commonMisconceptionList}}
</common_misconceptions>

Your task is to create an MCQ that addresses this learning objective and difficulty level:

<learning_objective>
{{learningObjective}}
</learning_objective>
<difficulty>
{{difficulty}}
</difficulty>
<difficulty_guidelines>

### For Easy Questions:

Simplicity: Create a straightforward question with clear, concise answer choices
Mental effort: Question should require minimal thought to solve with basic recall of facts
Distractors: Use weak distractors that are easy to dismiss
Obviousness: The correct answer should be relatively easy to identify
Time needed: Should be solvable in a few seconds

### For Medium Questions:

Simplicity: Introduce some complexity with longer answer choices or a more nuanced question stem
Mental effort: Require analysis and application of knowledge, not just simple recall
Distractors: Include plausible alternatives that require careful consideration
Obviousness: Ensure the correct answer doesn't immediately stand out
Time needed: Should take around 30-45 seconds to solve

### For Hard Questions:

Simplicity: Create complex questions with multiple concepts or detailed answer choices
Mental effort: Require synthesis of multiple concepts or careful analysis of evidence
Distractors: Design strong distractors that appear plausible and require critical thinking to dismiss
Obviousness: Make answer choices similar in structure and appearance so none stands out
Time needed: Should take a minute or more to carefully analyze and solve
</difficulty_guidelines>
   Follow these Steps to Create Your Multiple-Choice Question:
1. Analyze the lesson nodes and standard to identify key concepts relevant to the learning objective.
2. Formulate a question stem that directly addresses the learning objective and aligns with the standard.
3. Create one correct answer choice that accurately answers the question. The correct answer should not be the longest answer option.
4. Develop three plausible but incorrect answer choices (distractors). Ensure they are related to the topic but definitely wrong.
5. Adjust the complexity of the question and answer choices to match the specified difficulty level.
6. Review your question to ensure it stays within the assessment boundary.
7. Create a learning content blurb that helps students understand the concepts needed to answer the question correctly.

### Present Your Work in the Following Format:

<analysis>
1. List key concepts from the lesson nodes and standard, numbering them.
2. For each key concept, explain how it relates to the learning objective.
3. Brainstorm at least three potential question stems, numbering them.
4. Explain your choice of the final question stem.
5. For each distractor, evaluate its plausibility.
6. Explicitly state how the question's difficulty aligns with the specified level.
</analysis>
<question>
[Insert your question stem here]
</question>
<answer_options>

### [for Each Option a, B, C, and D, Provide the Following:]

Option text
Correctness flag (true/false)
Explanation for why this option is correct or incorrect
</answer_options>
<learning_content>
[Provide a concise but comprehensive explanation of the key concepts students need to understand to answer this question correctly. This should serve as a mini-lesson on the topic.]
</learning_content>
Ensure that your question accurately assesses the learning objective, aligns with the standard, and matches the specified difficulty level.

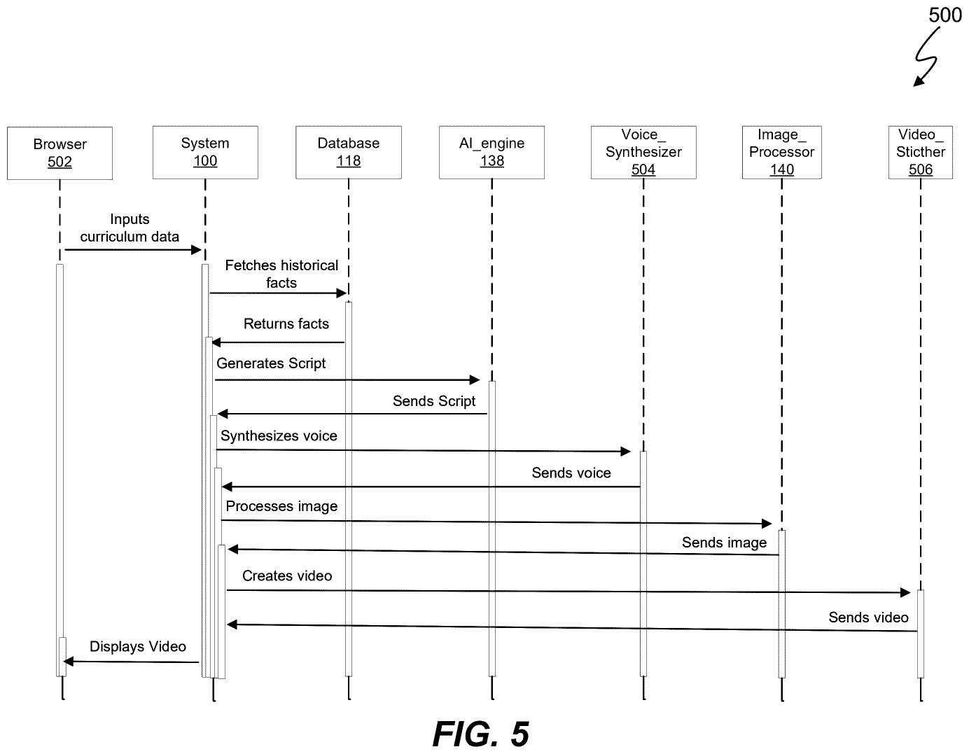

FIG. 5 depicts an exemplary AI guided and constrained, curriculum-aligned video generation sequence diagram 500 which is an embodiment of AI-based learning process 200 of FIG. 2. The AI guided and constrained, curriculum aligned video generation sequence diagram 500 for online learning with a collection of input data and sending back the processed data to the system to display a video via the user interface 104.

The AI guided and constrained, curriculum aligned video generation sequence diagram 500 illustrates a browser that is accessed by the user for online learning purposes. The AI-based learning system 100 collects curriculum data as input from browser 502. The database 118 stores the curriculum data and the historical data. Database 118, in response, sends facts collected from the curriculum data and the historical data. Further, AI Engine 138 uses the facts to generate scripts. The curriculum data and historical data are further used to obtain voice samples of the character to be presented as the AI tutor. The voice samples are synthesized by using text-to-speech technology and implementing advanced modulation capabilities to obtain an accurate voice that matches the AI tutor. The synthesized voice is sent to the AI engine 138.

Further, the AI-based learning system 100 obtains image information from the curriculum data and the historical data. The obtained image is processed with deep learning to create realistic visuals. The processed image is transferred to the AI engine 138. The curriculum-aligned video generation sequence diagram 500 also shows a video stitcher 506, which collects the generated scripts, the synthesized voice, and the processed image, and merges them to create the video content for the user. The video is displayed to the user via the user interface for the learning purpose.

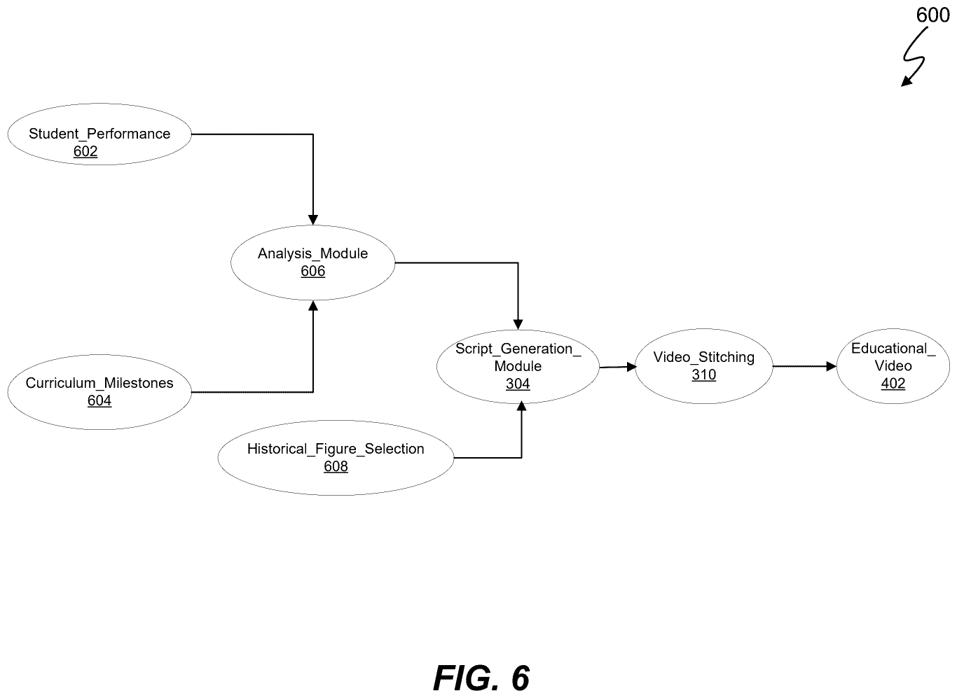

FIG. 6 depicts an exemplary curriculum-student alignment, video generation process 600 which is an embodiment of AI-based learning process 200. As shown, an analysis module 606 takes into consideration the student's performance 602 and curriculum milestones 604 to provide a more comprehensive support to the user. The analysis module 606 analyzes the student's performance 602 and the curriculum milestone 604 to identify the student's profile details, previous and current session details, learning history, current learning objectives, and so on. The analysis module 606 sends the collected information to the script generation module 304. The script generation 304 module utilizes a historical figure selection 608 to select historical image. The script generation module 304 further uses the collected student's performance data along with the historical images to provide curated content to the students that adapts to student's requirements. It should be noted that the generated script can be updated on a basis to ensure relevancy, accuracy, and alignment with the educational and historical databases.

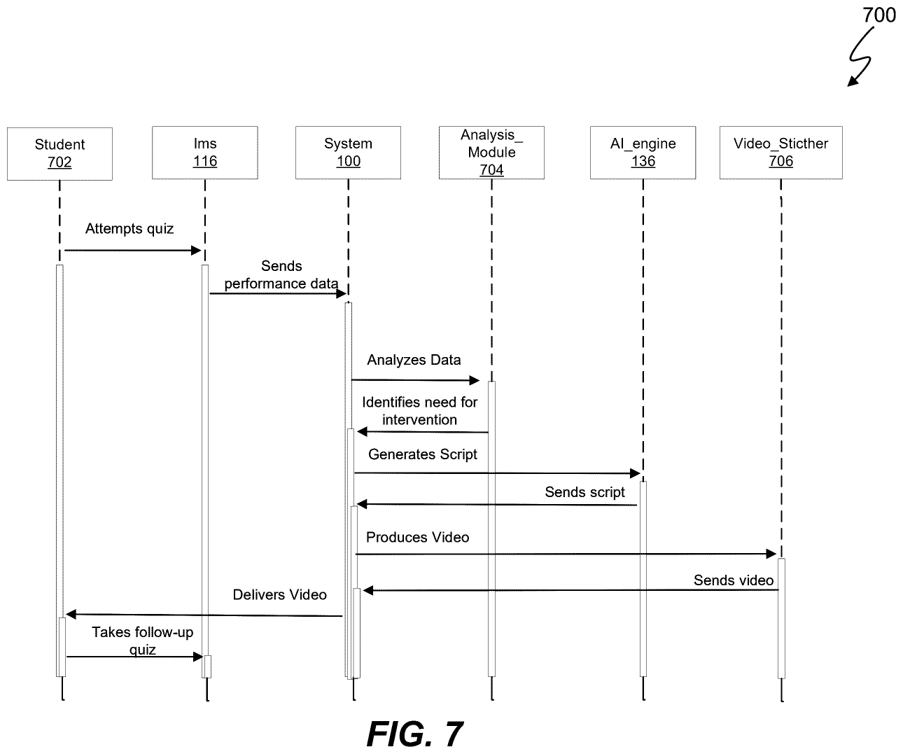

FIG. 7 illustrates an AI guided and constrained, feedback and video generation sequence diagram 700 which is an embodiment of AI-based learning system 100 of FIG. 1. The AI-based learning system 100 for adaptive and contextual learning utilizes inputs from the student. The video created in this scenario takes follow-up with the student. For example, AI guided and constrained, feedback and video generation sequence diagram 700, where student 702 attempts a quiz through the learning management system 116, the learning management system 116 sends the student's performance data to the AI-based learning system 100. An analysis module 704 is provided that analyzes the student's performance data. In case, the student has given any wrong answer on a particular topic, the analysis module signals the system to intervene and to provide additional support to the student on the particular topic. Now, AI Engine 138 generates scripts by considering the student's performance and the requirement to intervene at a particular time. The video is delivered to the student after combining the generated scripts, synthesized speech, and processed images, as explained in FIG. 6. Furthermore, the user watches the video and gains a better understanding of the particular topic. Then the user is required to attempt a follow-up quiz.

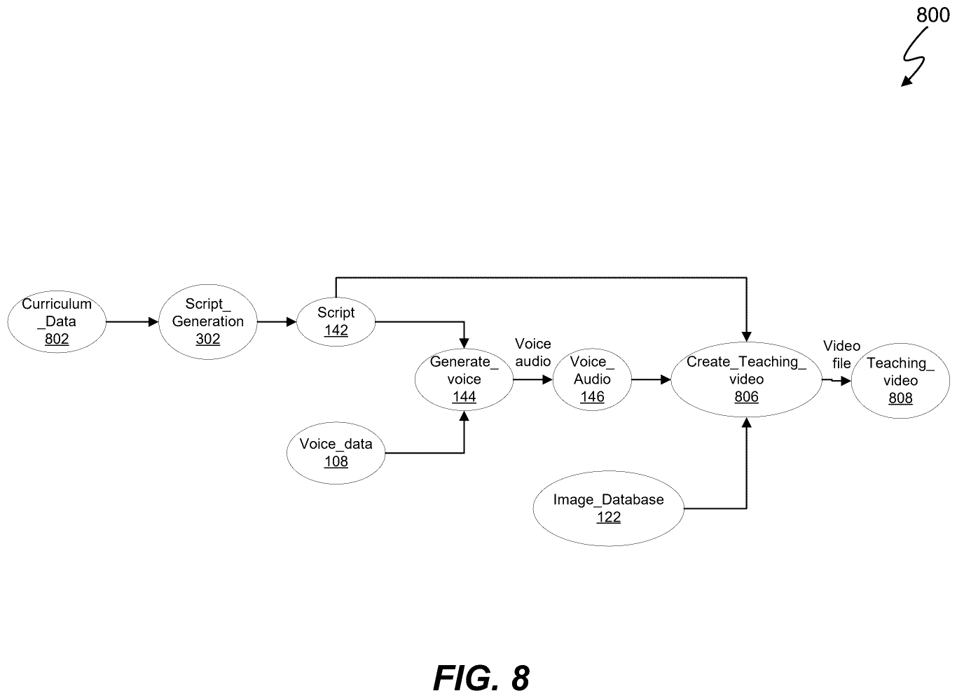

FIG. 8 represents a personalized learning video generation process 800 which is an embodiment of the AI-based learning process 200. The AI-based learning system 100 fetches curriculum data 802 to generates scripts. In this particular scenario, the voice 144 of the AI tutor is generated by combining data of the scripts and the voice data. The teaching video 806 is created by merging data from the image database 122 and input voice 146. Further, the video file is created and streamed to the user interface 104.

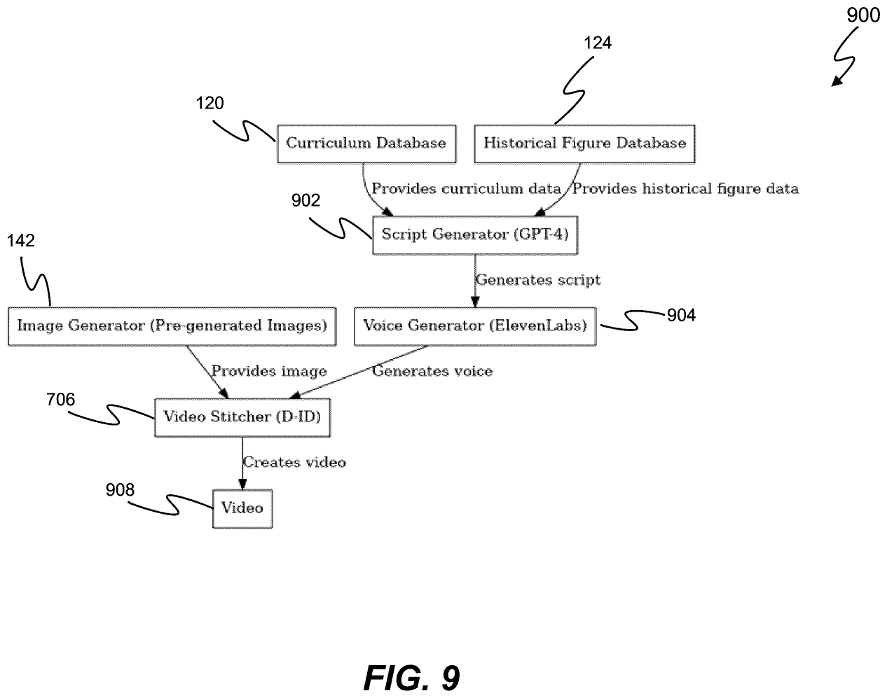

FIG. 9 depicts an exemplary diagram showing data structures 900 used to structure and organize data for video generation utilized by the AI-based learning system 100. In FIG. 9, the curriculum database 120 provides curriculum and the historical image database 124 provides historical figure data to the script generator 902. The script generator 902 can be a generative AI model that is a multimodal large language model. For example, GPT 4 can be used as the script generator. The script generator 902 based on the multimodal large language model utilizes retrieval augmented generation to incorporate information from provided sources into the generated response. Natural language processing techniques are employed to ensure an accurate integration of the information into the response.

The scripts generated by the script generator such as a large language model (e. g., GPT 4, GPT 40, etc.) are utilized by a voice generators such as a voice model for obtaining voice data. The voice data is then synthesized to match the voice of the historical persona using a voice generator 904. For example, the AI-based learning system 100 for adaptive and contextual learning can use ElevenLabs as the voice generator 904.

Images of the historical persona are processed with the help of deep learning techniques and create visuals of the AI tutor that match with features of the historical persona. For this, the image generator 142 can be used which includes pre-generated images. The generated voices and images are given to the video stitcher 706 for generating video 908 by combining the above data seamlessly. One of the examples of the video stitcher 706 could be but is not limited to, D-ID studio.

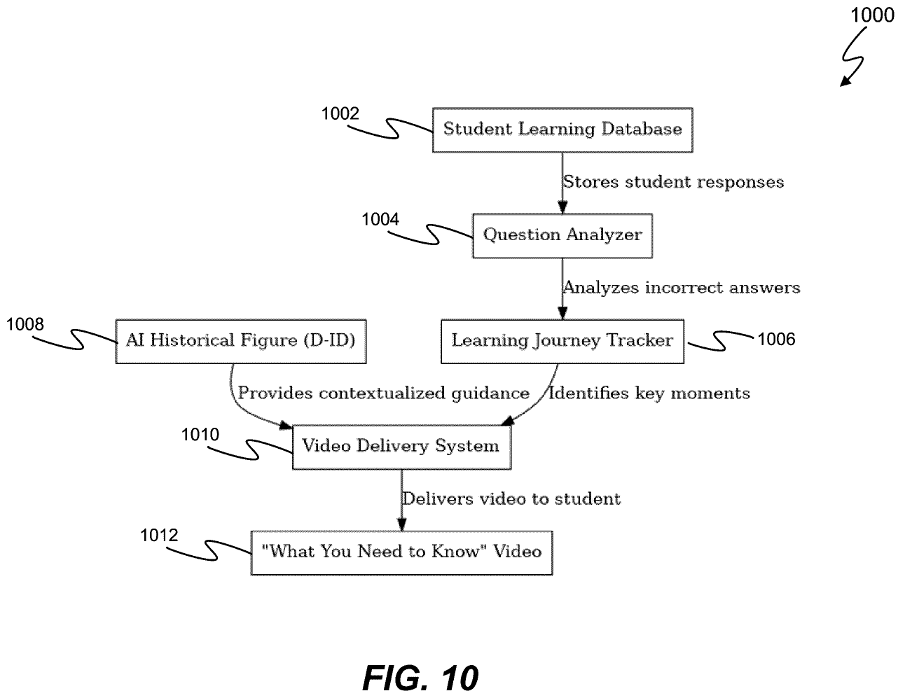

FIG. 10 depicts an exemplary diagram showing data structures 1000 used to structure and organize data for assistance to the student based on the student's performance and learning curve utilized by the AI-based learning system 100. As shown, a student learning database 1002 stores information, including but not limited to, the student's profile ID, student's learning curve, learning objective, current task taken, etc. A Question Analyzer 1004 stores the responses of the students for each question in a session. A learning journey tracker 1006 analyzes any incorrect answers given by the student. Further, the video content such as an AI historical FIG. 1008 obtained from the video stitcher 706 is provided to the video delivery system 1010. The video delivery system 1010 provides contextualized guidance and identifies key moments. In the scenario where the student has given a wrong answer, the AI tutor appears on the user interface 104 and intervenes in the student's learning journey to understand the student's learning requirement. For example, the video delivery system 1010 delivers a video to the student titled “What You Need to Know” 1012.

In an exemplary scenario, a student struggles with a physics concept. The student attempts a quiz and gives an incorrect answer. The AI-based learning system 100 for adaptive and contextualized learning triggers a video of Albert Einstein explaining the concepts in simple terms. In this manner, the AI-based learning system 100 guides the student toward a better understanding of the concept.

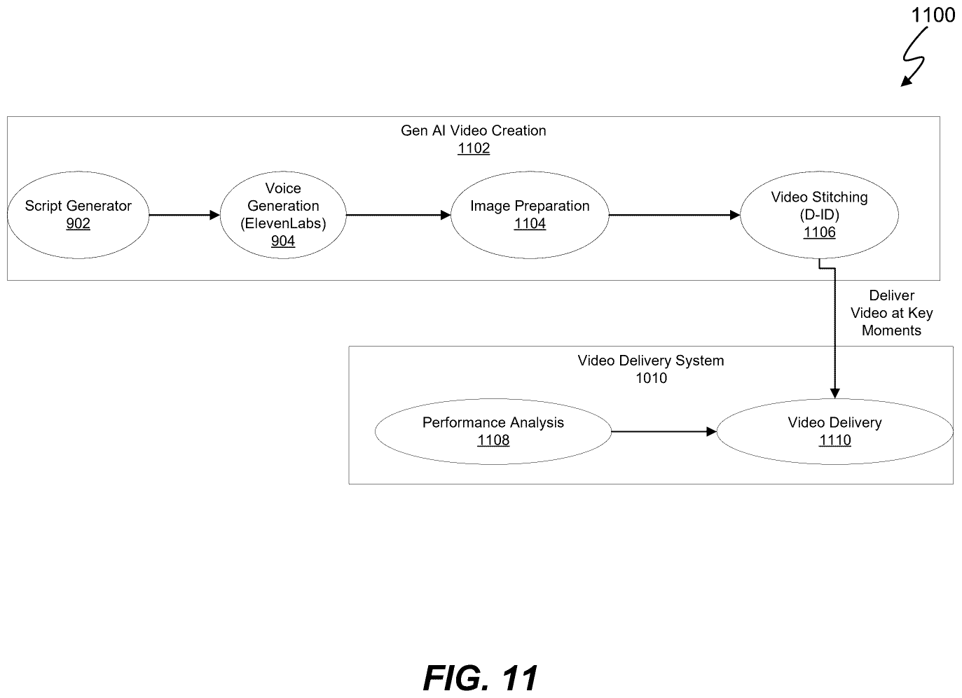

FIG. 11 depicts an exemplary learning video generation and delivery process 1100 for creating the learning video and delivering the video at key moments. The AI-based learning system 100 includes a video creation block 1102 and a video delivery system 1010. The video creation block 1102 uses Generative AI for its implementation. The video creation module involves script generation 902, voice generation 904, image generation 1104, and video stitching 1106 steps. Therefore, the output of the video stitching includes data obtained after combining the generated scripts, synthesized voice, and visuals representing the AI tutor. The output of the video stitching 1106 is provided and the video is delivered 1110 to the student at identified moments after considering the student's performance analysis 1108.

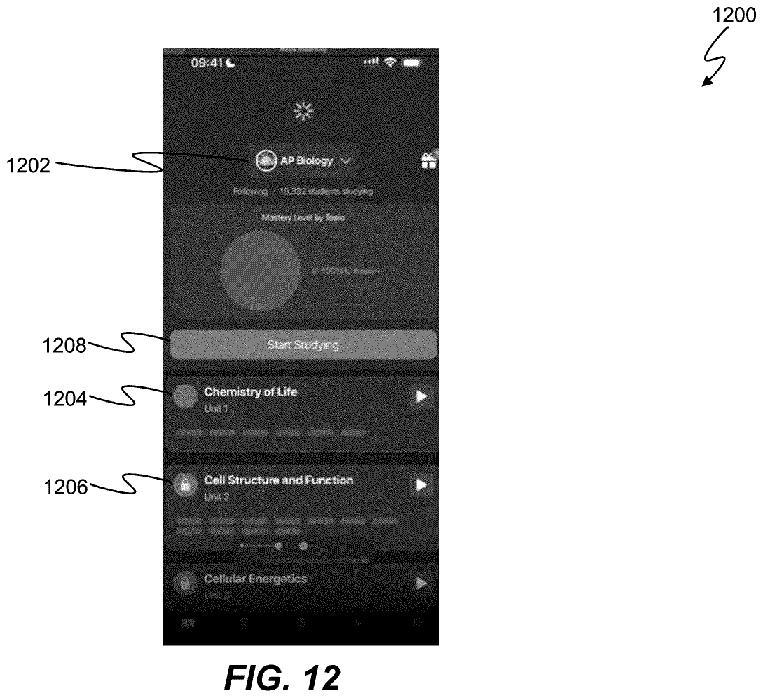

FIG. 12 depicts an exemplary educational user interface 1200 displaying educational topics that can be selected by the user for adaptive learning. The educational user interface 1200 can be accessed by the user through user interface 104 using the user device 102. The user device 102 may include any compatible device like smartphones, tablets, computers, and so on. The educational user interface 1200 discloses different units under each course. For instance, the course AP biology 1202 has different units such as Chemistry of Life 1204, Cell structure and function 1206. The user can click on a start studying button 1208 to interact with the content of the unit.

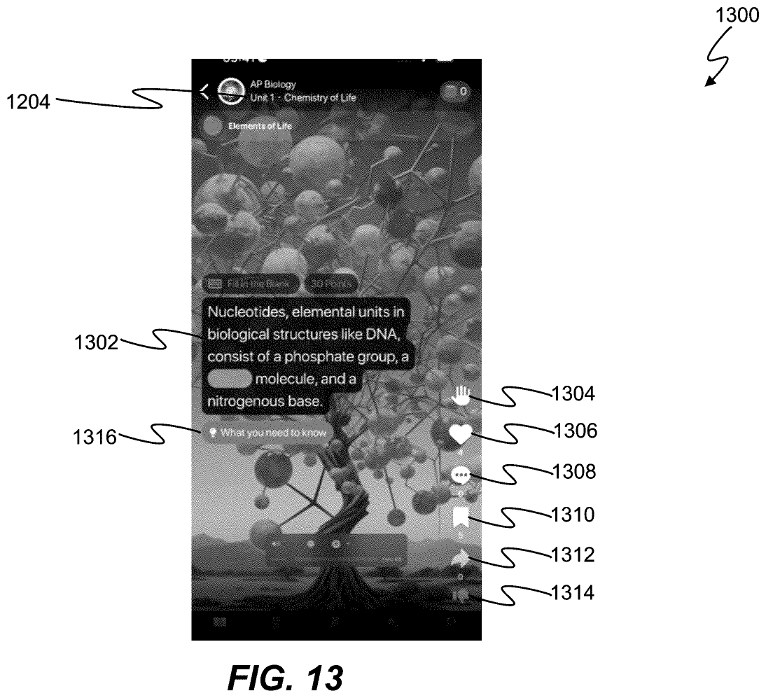

FIG. 13 depicts another exemplary educational user interface 1300 showing a question presented to the user while learning a unit. The user interface 1300 displays educational content based on the curriculum of the selected unit. The educational content can be fill-in-the blank questions, multiple choice questions, true/false and various other content type. In the shown embodiment, the educational user interface 1300 displays a fill-in-the blank question 1302.

The user interface 1300 comes with various interactive elements. The interactive elements include buttons like “Hand raise” 1304, “Like” 1306, “Comment” 1308, “Bookmark” 1310, “Share” 1312 and “Dislike” 1314. For instance, the user can click on hand raise 1304 button to interact with the AI tutor to understand the concept behind the question. Such an option is used by the user to interact with the AI tutor in a separate chat window. More details related to the aspect of interacting with the AI tutor via chat is explained in later section.

The user typically starts by attempting the question displayed via the contextual learning user interface 1300 to build knowledge on the selected topic. The user can anytime click on ‘what you need to know’ 1316 if he/she feels stuck on the presented fill-in-the blank question 1302. The prominent ‘What you need to know’ button 1316 assists the user/students who appear stuck on questions. This button 1316 begins pulsing after a short delay, signaling availability of help based on time spent, drawing from learning science principles to identify when assistance is needed.

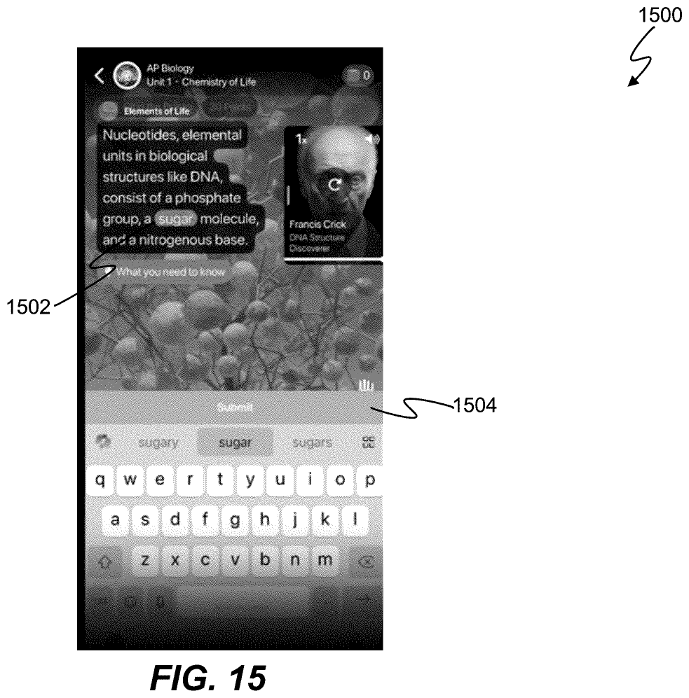

FIGS. 14 and 15 depict another exemplary user interfaces 1400 and 1500, where an AI tutor 1402 appears to explain concept behind a presented question. The AI tutor 1402 pops up in the form of a video, when the user clicks on ‘what you need to know’ 1316. The video of the AI tutor 1402 explains the concept behind the fill-in-the blank question 1302 along with the answer of the question. The AI tutor 1402 includes the historical figure of Francis crick 1404. The AI tutor 1402 comes to life to explain who discovered DNA, as well as the structure and function of nucleotides. The AI tutor 1402 helps students understand the concept of DNA in a simple and engaging way. The explanation takes just 30 seconds, making learning quick and easy. It should be noted that the AI tutor presents the concept behind the presented question that allows the user to understand the question well. While the content of the video explains the background knowledge behind the concept related to presented questions, the AI tutor does not provide a direct answer to the presented question. Therefore, the video content presented by the AI tutor enables to think about the correct answer based on shared knowledge. Subsequently, the user enters his/her answer in given blank 1502 via the user interface 1500, once the AI tutor 1402 finishes explaining the concept for the relevant topic. The user then clicks on submit button 1504 to submit his response, and to check if the submitted answer is correct.

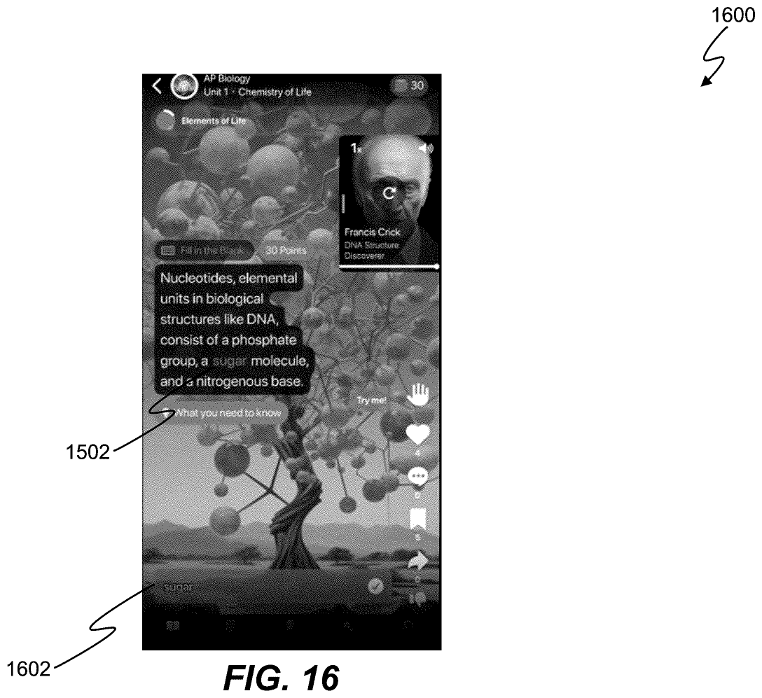

FIG. 16 depicts an exemplary user interface 1600 displaying the correct answer, as submitted by the user, to the presented question. The user interface 1600 depicts that the user has answered correctly for the fill-in-the-blank question 1302. The green color box 1602 with the answer indicates that the user answered the question correctly.

In the above example, the presented question is about nucleotides, which are building blocks of DNA and consist of a phosphate group, a certain molecule, and a nitrogenous base. Pressing the ‘What you need to know’ button 1502 activates the AI tutor. The teacher, depicted as a relevant historical figure, explains that nucleotides form nucleic acids like DNA and RNA, includes a phosphate group, a sugar molecule, and a nitrogenous base. The explanation highlights differences in sugars between DNA and RNA, emphasizing the importance for understanding genetic information. After the explanation, the student can input the answer (sugar) and proceed, earning points.

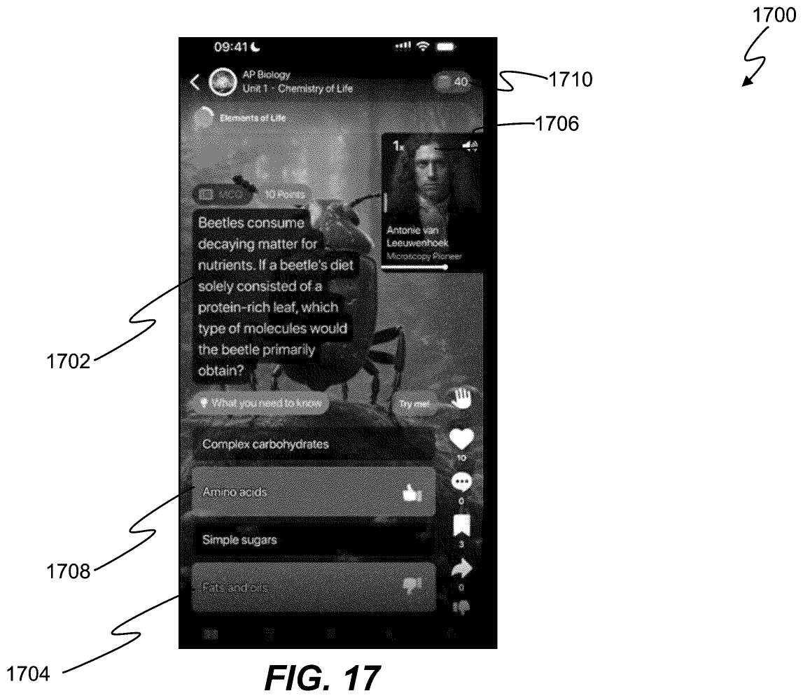

FIG. 17 depicts an exemplary user interface 1700 displaying how AI tutor pops up when the user submits an incorrect answer to presented question. The user attempts a multiple-choice question 1702 displayed via the user interface 1700. The user answers the multiple-choice question 1702 incorrectly. The AI-based learning system 100 presents a pre-recorded AI-tutor 1706 video with a script explaining the concept relevant to the multiple-choice question 1702. The AI tutor 1706 starts explaining the concept behind the question. The user can answer the question while the AI tutor 1706 explains the concept. The green color box 1708 displays that the user has answered the question correctly after watching the video.

When the user answers the question incorrectly 1704, mastery level of the user indicated as numeric 1710 decreases. If the user answers the question correctly, the mastery level of the user indicated as numeric 1710 will increase. Moreover, the mastery level of the user remains the same if the user watches the video before interacting with educational content displayed on the user interface.

Therefore, it should be noted that in the study mode, using ‘What you need to know’ (i.e. taking help) before answering awards points for eventual correct answers but does not affect mastery levels, as the assistance invalidates the performance signal. Without prior help, correct answers increase both points and mastery, while incorrect ones decrease mastery. Post-answer help is always available. For matching pairs questions, multiple targeted videos correspond to each pair, allowing selection of help for specific stuck points.

Further, beyond timing-based help, the system also offers feedback based on correctness. If a student answers a multiple-choice question incorrectly, a teaching video automatically appears. For instance, in this example, the user incorrectly selects “fats and oils” in response to a question about what molecules a beetle would obtain from a protein-rich leaf. As a result, the AI tutor video explains that the correct answer is amino acids, found in proteins.

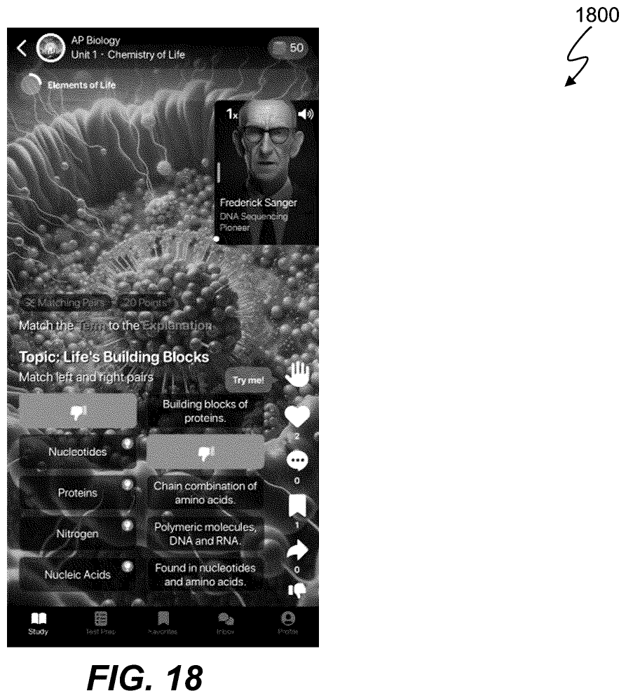

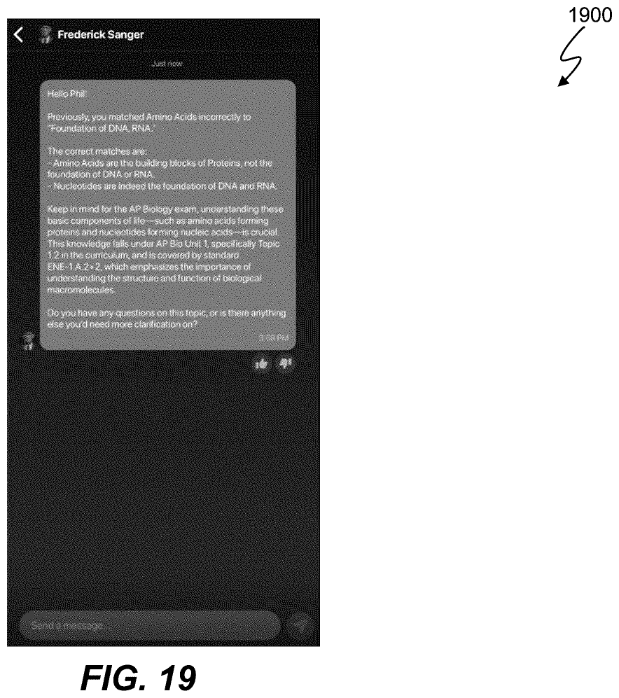

FIGS. 18 and 19 depict a set of exemplary educational user interfaces, where the AI tutor appears at a specific time to explain a concept and the user interacts with the AI tutor via a chat option, as needed.

FIG. 18 depicts an exemplary educational user interface 1800 displaying a ‘Match left and right pairs’ question type. The user interacts with the presented question via the user interface 1800. The presented question is related to AP Biology subject . . . . In the shown example, the user selects an incorrect answer to the presented ‘Match left and right pairs’, which is indicated by thumbs-down icon on the user interface 1800. As a result, an AI tutor of Frederick Sanger appears. He is one of the prominent chemist who has won Nobel Prize in Chemistry for his contributions in protein and DNA sequencing studies related to Insulin and Human Genome Project, respectively. Since the presented question is related to similar domain, he is explaining the concept in the presented video.

The user can also interact with Frederick Sanger by clicking on ‘Hand raise’ button 1304. As a result, a user interface 1900 showing a chat window appears. The user can interact with the AI tutor here to get more clarity about the concept related to the asked questions. The ‘Hand raise’ button 1304 may pulse after a delay to prompt students if they seem stuck. In various question types, such as multiple-choice, the AI tutor activates immediately upon a wrong answer, explaining the correct one while allowing the student to continue interacting or skip. Even on correct answers, the video plays to reinforce context. Additionally, the user interface 1800 may present a waving hand icon that appears on wrong answers, inviting a text-based chat with the AI tutor for deeper exploration on the topic. The chat's initial response directly addresses the error and provides context. In one example, the video content is the same regardless of correct or incorrect answers, however, it should be noted that the content of the video may vary to tailor feedback on submitted answer.

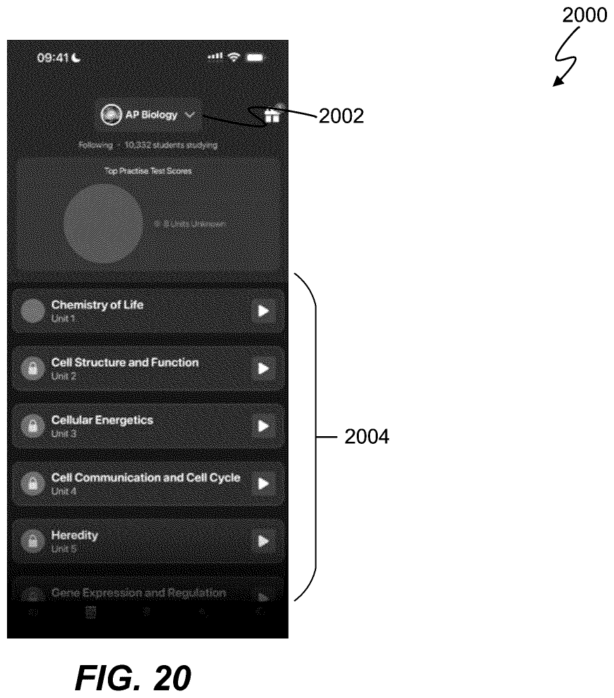

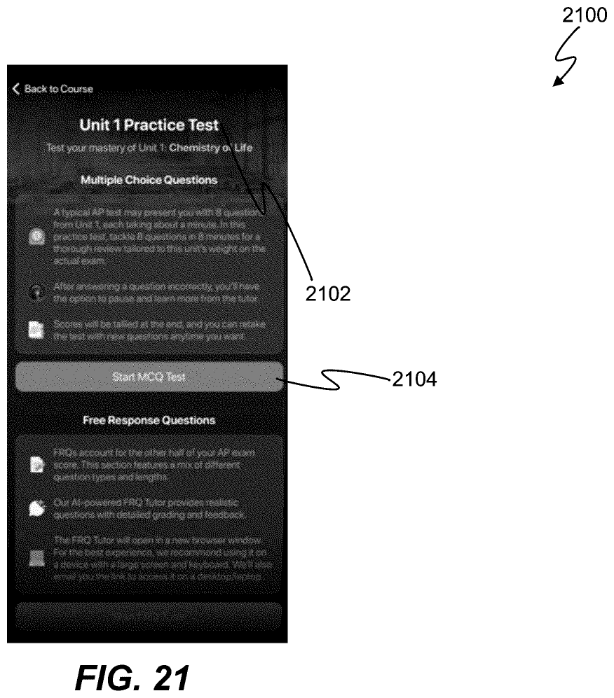

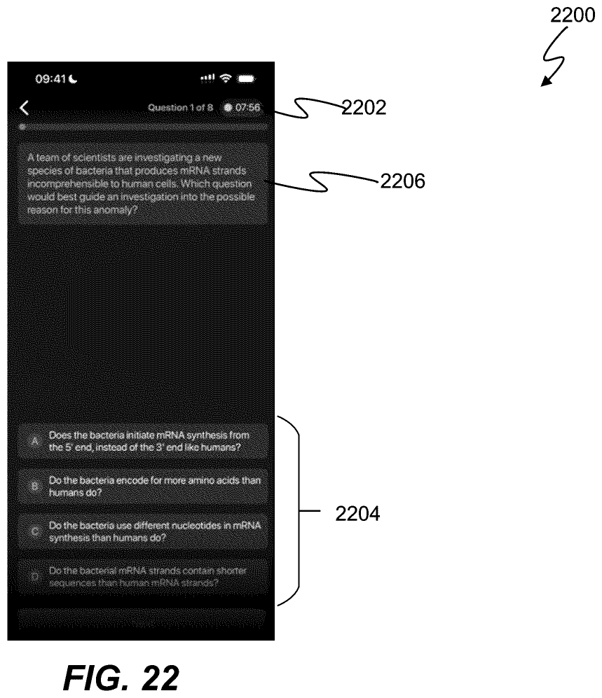

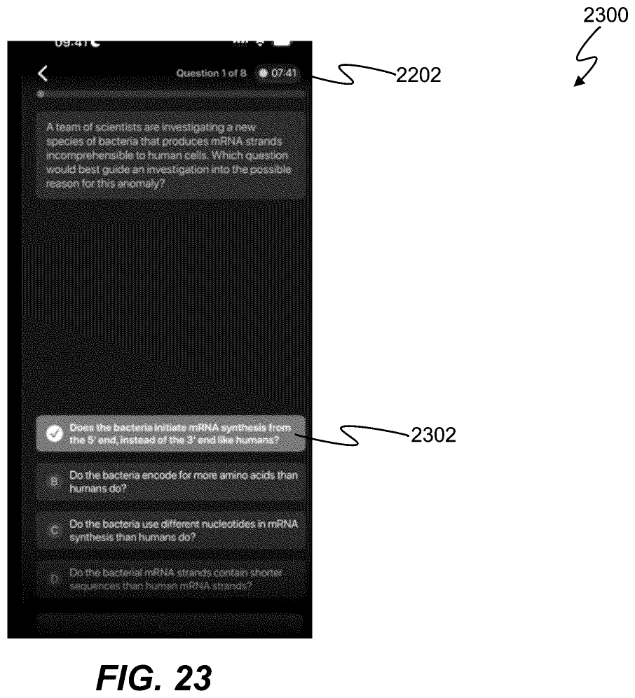

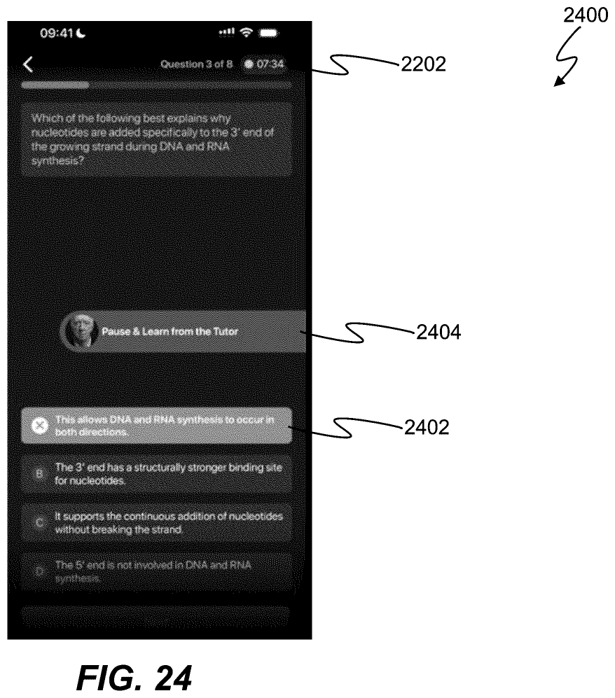

FIGS. 20-24 depict an exemplary embodiment where the AI tutor pops up while the user is appearing for a practice test in an online practice test mode. As shown, a user interface 2000 shows various units 2004 included in AP biology 2002 subject. The user can select unit of his choice for practice test. In this embodiment, the user selects ‘Unit 1 Practice Test’ 2102 and clicks on ‘Start MCQ test’ 2104 to initiate the practice test. Upon initiating the practice test, user interface 2200 shows a first MCQ 2206 along with answer options 2204. The user selects one option from the given answer options 2204 as his/her answer to the presented MCQ 2206. The user interface 2200 also includes a timer 2202 indicating time lapsed from a total time given to attempt the entire practice test. For instance, if the practice test includes eight questions, the timer 2202 may provide eight (08:00) minutes for the user to attempt all eight questions.

Once the user submits response to the presented question, a user interface 2300 indicates that the submitted answer is correct 2302. The user interface also indicates the time left as 07:41 minutes for attempting the remaining questions. In another user interface 2400, the user submits an incorrect response 2402. As a response, an option ‘Pause and learn from the tutor’ 2404 appears. Once the user chooses the option 2404, an AI tutor appears who explains the concept behind the asked MCQ.

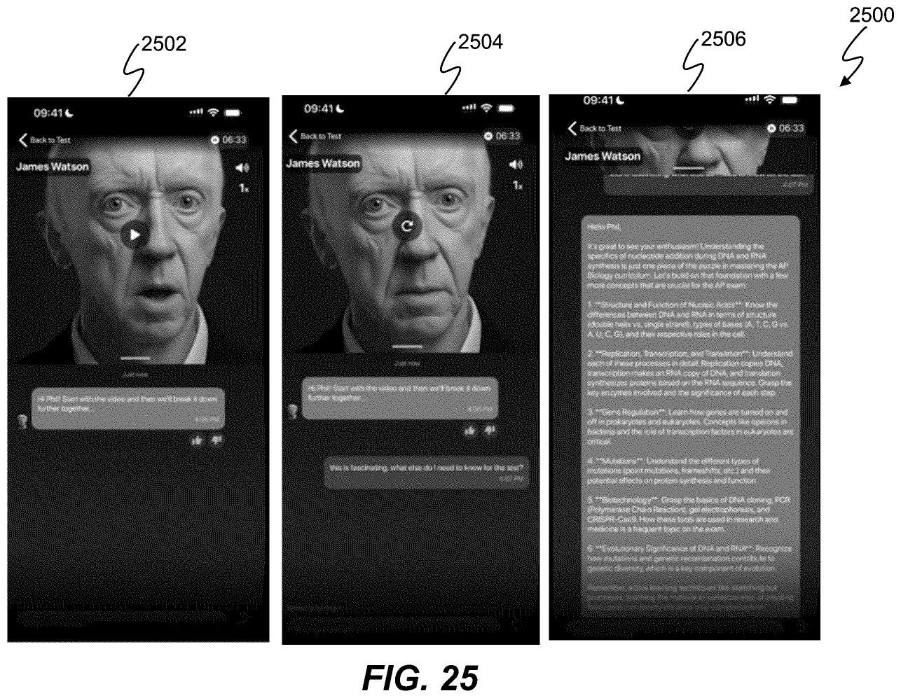

FIG. 25 depicts a user interface 2500 where the user interacts with an AI tutor via a chat option, while the AI tutor is explaining a concept in parallel. The AI tutor appears 2502 upon clicking ‘Pause and learn from the tutor’ 2404, in the test prep mode.

In the test prep mode, which involves timed practice tests, the AI tutor does not appear on correct answers to maintain test flow. On wrong answers, the “Pause and Learn from the Tutor” 2404 option appears, pausing the timer upon selection. This automatically plays the relevant video 2504 and enables chat with the AI teacher, personalized to the student's name and the question. The chat can extend as needed, covering additional concepts or memorization techniques. Upon exiting, the timer resumes. No second attempts are allowed on the question, preserving test integrity, but the learning moment is captured immediately when the student's mind is engaged. The student can also chat 2506 with the AI tutor while the AI tutor explains the concept behind the presented MCQ. Such chat provides a written description that allows the student to understand the concept fully and ask any relevant queries.

The user can pause and replay the video. The AI tutor 2002 also provide customized responses to the queries asked by the user.

In the above explained adaptive learning embodiments, the continuous collection and analysis of various forms of data from the student's activity is performed in a basis. This includes the user responses to quiz questions, tasks, and exercises, providing insights into what the user know and where the user struggles. Performance metrics are also gathered, such as response accuracy, time taken to complete tasks, the number of attempts needed, and the progression rate over time. In addition, interaction data is recorded, which includes patterns like how often the student engages with the content, what learning paths they choose, and how the user interacts with multimedia resources. This adjusts the difficulty level, content type, and delivery method in, for example, real-time, creating a personalized learning experience that adapts to each student's evolving needs and performance trends.

The engagement of the user is further enhanced by transforming the virtual character into an animated tutor that not only presents educational content but does so while simulating lifelike physical movements and voice output. The tutor is modeled to represent the historical figure, adopting the visual appearance, style of speaking, and characteristic gestures of the corresponding historical figure. The animation includes facial expressions, body language, and other non-verbal cues that help the tutor appear more realistic and relatable. Audio is synchronized with the tutor's mouth movements, and the voice can be modulated to match the tone and dialect associated with the historical figure.

Once the tutor is established, a dynamic content is generated that animates the tutor in response to the student's ongoing interaction. The student's inputs, such as answers, questions, behavioral cues, and engagement patterns, are processed to determine appropriate feedback and instructional dialogue. This feedback is used to animate the tutor so that the tutor speaks, gestures, and reacts contextually. However, these responses are not arbitrary; they are constrained and guided by the educational content and aligned with established curriculum standards to ensure that every interaction maintains pedagogical value. This means that while the tutor responds in a personalized and dynamic way, the content delivered by the tutor remains focused on achieving specific learning outcomes.

It should be noted that all content, including questions, answers, and AI teacher scripts, can be pre-generated simultaneously using AI prompts tied to curriculum standards. This ensures uniqueness for each item and direct linkage between the question and explanatory video. Generation involves text, image, voice, and video components, drawing from enhanced curriculum data like key terms. The process integrates historical facts and samples to create the AI tutors.

The historical avatars used as AI tutors not only provide the answer but deliver a compact explanation aligned with the persona of the character, within a 30-second video. Such a design ensures that students not only memorize answers but internalize the underlying concept through an engaging narrative. The AI content supports long-term comprehension and is directly aligned with tested curriculum standards.

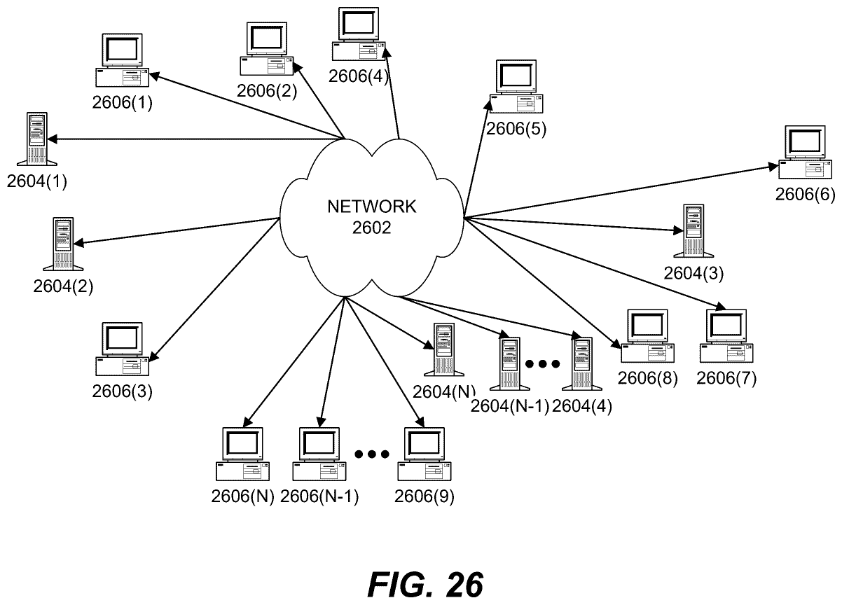

FIG. 26 is a block diagram illustrating a network environment in which the AI-based learning system 100 and the AI-based learning process 200 using Artificial Intelligence for adaptive learning may be practiced. Network 2602 (e.g. a private wide area network (WAN) or the Internet) includes several networked server computer systems 2604(1)-(N) that are accessible by client computer systems 2606(1)-(N), where N is the number of server computer systems connected to the network. Communication between client computer systems 2606(1)-(N) and server computer systems 2604(1)-(N) typically occurs over a network, such as a public switched telephone network over asynchronous digital subscriber line (ADSL) telephone lines or high-bandwidth trunks, for example, communications channels providing T1 or OC3 service. Client computer systems 2606(1)-(N) typically access server computer systems 2604(1)-(N) through a service provider, such as an internet service provider (“ISP”) by executing application-specific software, commonly referred to as a browser, on one of client computer systems 2606(1)-(N).

Client computer systems 2606(1)-(N) and server computer systems 2604(1)-(N) are specialized computers programmed to improve conventional computer systems to implement and utilize the AI-based learning system 100 and the AI-based learning process 200 using Artificial Intelligence for adaptive learning. The type of computer system that can be specially programmed to implement and utilize the AI-based learning system 100 and the AI-based learning system 100 process 200 using Artificial Intelligence for adaptive learning includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the AI-based learning system 100 and the AI-based learning system 100 process 200 using Artificial Intelligence for adaptive learning can be implemented using code stored in a tangible, non-transient computer-readable medium and executed by one or more processors. In at least one embodiment, the AI-based learning system 100 and the AI-based learning system 100 process 200 using Artificial Intelligence for adaptive learning can be implemented completely in hardware using, for example, logic circuits and other circuits including field programmable gate arrays.

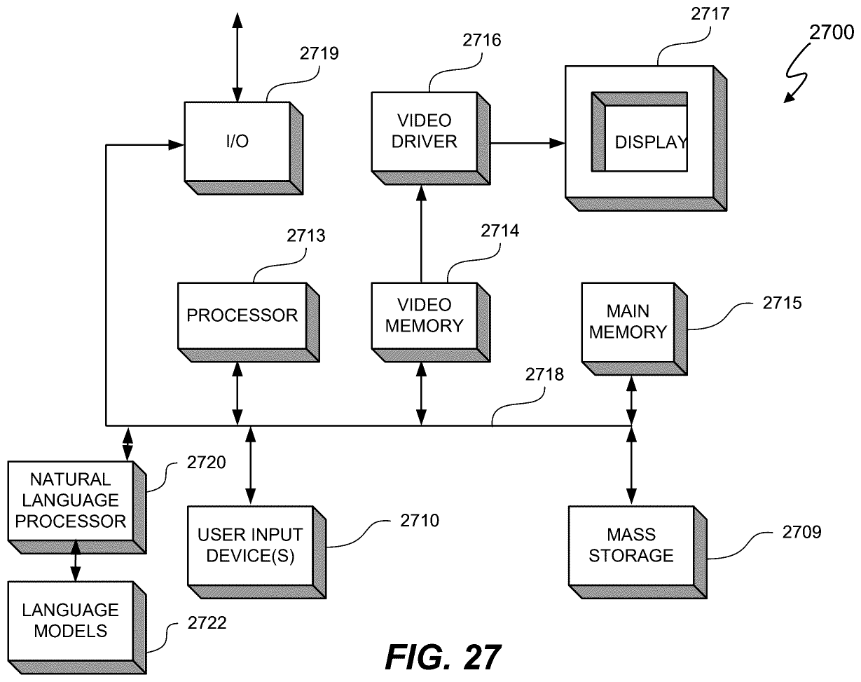

Embodiments of the AI-based learning system 100 and the AI-based learning system 100 process 200 using Artificial Intelligence for adaptive learning can be implemented on a computer system such as a special-purpose, special-programmed computer 2700 illustrated in FIG. 27. Input user device(s) 2710, such as a keyboard and/or mouse, are coupled to a bi-directional system bus 2718. The input user device(s) 2710 are for introducing user input to the computer system and communicating that user input to processor 2713. The computer system of FIG. 27 generally also includes a non-transitory video memory 2714, non-transitory main memory 2715, and non-transitory mass storage 2709, all coupled to bi-directional system bus 2718 along with input user device(s) 2710 and processor 2713. The mass storage 2709 may include fixed and removable media, such as a hard drive, one or more CDs or DVDs, solid state memory including flash memory, and other available mass storage technology. Bus 2718 may contain, for example, 32 of 64 address lines for addressing video memory 2714 or main memory 2715. The system bus 2718 also includes, for example, an n-bit data bus for transferring DATA between and among the components, such as CPU 2709, main memory 2715, video memory 2714, and mass storage 2709, where “n” is, for example, 32 or 64. Alternatively, multiplex data/address lines may be used instead of separate data and address lines.

I/O device(s) 2719 may provide connections to peripheral devices, such as a printer, and may also provide a direct connection to a remote server computer systems via a telephone link or to the Internet via an ISP. I/O device(s) 2719 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 2709, into main memory 2715 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2713, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2715 is comprised of dynamic random access memory (DRAM). Video memory 2714 is a dual-ported video random access memory. One port of the video memory 2714 is coupled to the video amplifier 2716. The video amplifier 2716 is used to drive the display 2717. Video amplifier 2716 is well known in the art and may be implemented by any suitable means. This circuitry converts pixel DATA stored in video memory 2714 to a raster signal suitable for use by display 2717. Display 2717 is a type of monitor suitable for displaying graphic images.

The computer system described above is for purposes of example only. The AI-based learning system 100 and the AI-based learning system 100 process 200 using Artificial Intelligence for adaptive learning may be implemented in any type of computer system programming or processing environment. It is contemplated that the AI-based learning system 100 and the AI-based learning system 100 process 200 using Artificial Intelligence for adaptive learning might be run on a stand-alone computer system, such as the one described above. The AI-based learning system 100 and the AI-based learning system 100 process 200 using Artificial Intelligence for adaptive learning might also be run from a server computer systems system that can be accessed by a plurality of client computer systems interconnected over an intranet network. Finally, the AI-based learning system 100 and the AI-based learning system 100 process 200 using Artificial Intelligence for adaptive learning may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method of guiding an AI (Artificial Intelligence) engine to generate content and deliver the content to a user using a generated AI tutor via an online learning platform, the method comprises:
executing code using one or more processors of a computer system to cause the computer system to perform operations comprising:
collecting one or more input data from a plurality of sources, wherein the plurality of sources include educational databases, historical databases, image, and voice databases;
generating prompts to guide and constrain the AI engine to create the content based on the received one or more input data;
providing the generated prompts to the AI engine to guide and constrain the AI engine to perform:
creating a script of the content that aligns with a curriculum standard;
preparing AI tutor generation based on data received from the educational databases, and historical databases;
employing a text-to-speech converter that synthesizes a voice that mimics the voice of the AI tutor and
generating a visual representation of the AI tutor that is linked to the script; and
integrating the generated script, synthesized voice, and visual representation to generate an animated video of the AI tutor to be used during an online learning session; and
receiving the AI-generated video and displaying it to the user using the online learning platform, wherein the generated video is displayed at a specific time.

2. The method of claim 1 wherein the AI tutors are tutors displayed on a user interface of the online learning platform to guide and educate the user during an online learning session

3. The method of claim 1 wherein one or more input data from the plurality of sources includes curriculum data from the educational databases, historical facts and biographical data from the historical databases, image data, and voice samples related to the AI tutor from the image, and voice databases.

4. The method of claim 1 wherein the specific time at which the generated video is displayed to the user includes the timings where the user faces difficulty in understanding the concepts or when an incorrect answer is provided by the user for the generated content.

5. The method of claim 1 wherein the AI engine utilizes NLP (Natural Language Processing) techniques to generate the educational script based on the received prompt.

6. The method of claim 1 wherein the generated script is updated on a basis to ensure relevancy, accuracy, and alignment with the educational and historical databases.

7. The method of claim 1 wherein synthesizing the voice that mimics the AI tutor using the text-to-speech converter further comprises:
training the text-to-speech converter using voice samples of the AI tutor obtained from the audio databases; and
fine-tuning the text-to-speech converter's output to match the tone, pitch, and accent of the AI tutor.

8. The method of claim 1 wherein creating the visual representation of the AI tutor further comprises:
analyzing historical images and portraits of the AI tutor using a guided and constrained AI engine; and
creating a realistic and animated image of the AI tutor that accurately represents the AI tutor by ensuring that the visual representation aligns with the historical and cultural context of the AI tutor.

9. The method of claim 1 wherein monitoring the user's performance during the online learning session for timely delivery of the generated video comprises:
collecting user performance data in from the online learning platform, including the quiz results, correct or incorrect answers, and so on; and
setting the criteria for delivery of the video, including, immediately after the user gives the incorrect answer, when the user asks for help from the tutor, and so on.

10. The method of claim 1 wherein the AI engine is further guided and constrained to:
animate the AI tutor's facial movements and lip-syncing based on the generated audio response; and
incorporate visual cues to enhance realism, such as eye movements and gestures.

11. The method of claim 1 wherein the AI tutors used in the generated video depend on the type and intent of question content during the online learning session.

12. The method of claim 1 wherein the user can provide feedback through various surveys and interactions with the online learning platform used for future content generation.

13. The method of claim 1 wherein integrating the generated script, synthesized voice, and visual representation to generate an animated video of the AI tutor to be used during an online learning session comprises:
generating the AI prompt to cause the AI engine to generate a voice of the AI tutor that mimics an historical character.

14. A system to guide and constrain an AI (Artificial Intelligence) engine to generate content and deliver the content using an AI tutor to a user using an online learning platform comprises:
one or more processors; and
a memory, coupled to the one or more processors, that stores code that when executed cause the one or more processors to perform operations comprising:
collecting one or more input data from a plurality of sources using a collector, wherein the plurality sources include educational databases, historical databases, image, and voice databases;
generating prompts using a prompt generator to guide the AI engine to create the content based on the received one or more input data;
transferring the generated prompts to the AI engine to:
create a script of the content that is to be provided to the AI tutor using a text generator based on data received from the educational databases, and historical databases;
employing a text-to-speech converter for synthesizing a voice that mimics the voice of the AI tutor;
create a visual representation of the AI tutor using an image generator based on deep learning techniques;
integrating the generated script, synthesized voice, and visual representation to generate a video using a video integration module, wherein the video of the AI tutor is used during an online learning session; and
receiving the AI-generated video and displaying it to the user via a user interface on the online learning platform, wherein the generated video is delivered to the user at a specific time.

15. The system of claim 14 wherein the video integration module comprises a motion synthesizer configured to animate the AI tutor's facial expressions and gestures to match the synthesized speech.

16. The system of claim 14 wherein the collector automatically updates input data on a basis from educational databases, historical databases, image, and voice databases at regular intervals.

17. The system of claim 14 wherein the text-to-speech converter utilizes a neural network to improve the naturalness and emotional expressiveness of the synthesized speech and image generator utilizes a machine learning algorithm to create more lifelike and expressive visual representations of the AI tutor.

18. The system of claim 14 wherein the AI engine is configured to analyze the user's performance during the online learning session using machine learning algorithms to identify 2 learning gaps and display the video where the AI tutor guides and educates the user to address these gaps.

19. The system of claim 14 wherein the user can provide feedback using a feedback module through various surveys and interactions with the online learning platform used for future content generation.
